(19) United States
(12) Patent Application Publication
(10) Pub. No.: US 2017/0230793 A1
(43) Pub. Date: Aug. 10, 2017

(54) SYSTEMS AND METHODS FOR SWITCHING WIRELESS COMMUNICATION TECHNOLOGIES

(71) Applicant: Sharp Laboratories of America, Inc., Camas, WA (US)

(72) Inventor: Edward Masami Sugiyama, Vancouver, WA (US)

(21) Appl. No.: 15/018,612

(22) Filed: Feb. 8, 2016

(51) Int. Cl. H04W 4/02; H04W 4/00

(52) U.S. Cl. CPC H04W 4/023; H04W 4/008

(57) ABSTRACT

A method by a monitoring device is described. The method includes calculating a distance from the monitoring device to an announcing device based on one or more long range signals received by a long range radio. The method also includes transmitting short range radio configuration parameters using the long range radio when the distance is within an operating range of a short range radio. The method further includes switching automatically from the long range radio to the short range radio based on the short range radio configuration parameters.

### TECHNICAL FIELD

The present disclosure relates generally to communication systems. More specifically, the present disclosure relates to switching wireless communication technologies between devices.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may be configured to communicate with each other using multiple communication technologies. For example, a wireless communication device may include a long range radio and a short range radio. As illustrated by this discussion, systems and methods that improve switching wireless communication technologies between devices may be beneficial.

### BRIEF DESCRIPTION OF THE DRAWINGS

FIG. 1 is a block diagram illustrating a wireless communication system in which systems and methods for switching wireless communication technologies may be implemented;

FIG. 2 is a flow diagram illustrating a method for switching wireless communication technologies between devices;

FIG. 3 is a flow diagram illustrating another method for switching wireless communication technologies between devices;

FIG. 4 is a flow diagram illustrating yet another method for switching wireless communication technologies between devices;

FIG. 5 is a block diagram illustrating an implementation of a wireless communication system for switching wireless communication technologies;

FIG. 6 is a sequence diagram illustrating an implementation of switching between wireless communication technologies;

FIG. 7 illustrates various components that may be utilized in a communication device; and

FIG. 8 is a block diagram illustrating one implementation of a communication device in which systems and methods for switching wireless communication technologies between devices may be implemented.

### DETAILED DESCRIPTION

A method by a monitoring device is described. The method includes calculating a distance from the monitoring device to an announcing device based on one or more long range signals received by a long range radio. The method also includes transmitting short range radio configuration parameters using the long range radio when the calculated distance is within an operating range of a short range radio. The method further includes switching automatically from the long range radio to the short range radio based on the short range radio configuration parameters.

The long range radio may be a long-term evolution (LTE) radio with proximity services (ProSe). The one or more long range signals may include a ProSe broadcast announcement.

The short range radio configuration parameters may be broadcast in a restricted ProSe message. The restricted ProSe message may include security and device identification parameters. ProSe functionality on the long range radio may be disabled upon switching to the short range radio.

The short range radio may be a Bluetooth radio. Alternatively, the short range radio may be a Wi-Fi radio.

The method may also include pairing the short range radio using the short range radio configuration parameters transmitted by the long range radio. At least some long range radio functionality may be disabled upon switching to the short range radio.

A monitoring device is also described. The monitoring device includes a processor and memory in electronic communication with the processor. Instructions stored in the memory are executable to calculate a distance from the monitoring device to an announcing device based on one or more long range signals received by a long range radio. The instructions are also executable to transmit short range radio configuration parameters using the long range radio when the distance is within an operating range of a short range radio. The instructions are further executable to switch automatically from the long range radio to the short range radio based on the short range radio configuration parameters.

A method by an announcing device is also described. The method includes transmitting one or more long range signals from a long range radio. The one or more long range signals include a value that a monitoring device may use to calculate a distance from the monitoring device to an announcing device. The method may also include receiving short range radio configuration parameters using the long range radio. The method may further include switching automatically from the long range radio to a short range radio based on the short range radio configuration parameters.

An announcing device is also described. The announcing device includes a processor and memory in electronic communication with the processor. Instructions stored in the memory are executable to transmit one or more long range signals from a long range radio. The one or more long range signals include a value that a monitoring device may use to calculate a distance from the monitoring device to an announcing device. The instructions are also executable to receive short range radio configuration parameters using the long range radio. The instructions are further executable to switch automatically from the long range radio to a short range radio based on the short range radio configuration parameters.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12 and/or 13). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may refer to any set of communication channels over which the protocols for communication between a UE and eNB that may be specified by standardization or governed by regulatory bodies to be used for International Mobile Telecommunications-Advanced (IMT-Advanced) or its extensions and all of it or a subset of it may be adopted by 3GPP as licensed bands (e.g., frequency bands) to be used for communication between an eNB and a UE. “Configured cells” are those cells of which the UE is aware and is allowed by an eNB to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

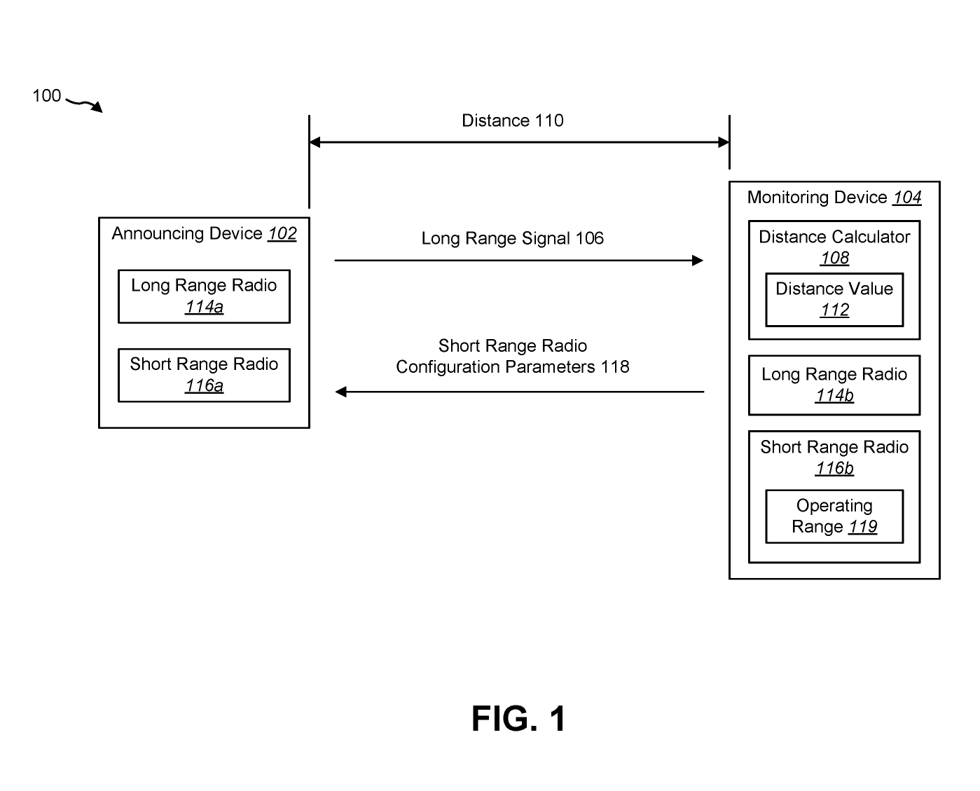

FIG. 1 is a block diagram illustrating a wireless communication system 100 in which systems and methods for switching wireless communication technologies may be implemented. The system 100 may include a plurality of communication devices. In an implementation, the system 100 may include an announcing device 102 and a monitoring device 104.

Communication devices may be configured with multiple radios. These radios may be capable of operating at different ranges. A communication device may have one or more long range radios 114. Examples of a long range radio 114 include cellular transceivers (e.g., transmitter and receiver). A long range radio 114 may be configured to operate on one or more cellular networks (e.g., GSM, CDMA, LTE, etc.).

A communication device may also include one or more short range radios 116. A short range radio 116 may have an operating range 119 that is less than the operating range of the long range radio 114. An example of a short range radio 116 is a radio configured to operate according Bluetooth (BT) specifications (referred to herein as a BT radio). Another example of a short range radio 116 is a radio configured to operate according to IEEE 802.11 standard specifications (referred to herein as a Wi-Fi radio). Additional short range radios may include Ant+, RFID, and NFC.

Communication devices (e.g., cellular and mobile devices) capable of communicating with other devices often use wireless communication technologies including Bluetooth (BT) and Wi-Fi. In addition, the long range radio 114 may be configured with Proximity Services (ProSe) functionality. ProSe is a communication protocol defined in Release 12 and Release 13 of the 3GPP standards.

Use of ProSe is beneficial due to the long operating range of the long range radio 114. In the case of an LTE radio, the operating range may be approximately 800 meters. By comparison, the operating range 119 of a Wi-Fi radio is approximately 30 meters and BT radio is approximately 10 meters. However, ProSe requires the use of cellular network radio resources. Additionally, the power consumption of ProSe is higher than the power consumption associated with Wi-Fi and BT.

Another problem with communication devices that have a long range radio 114 and a short range radio 116 is switching between wireless technologies (e.g., ProSe, Wi-Fi, BT). There is currently no easy approach to switch wireless technologies during communication between devices. Manually switching radios, such as Wi-Fi to Bluetooth is cumbersome and requires user interaction. Users of devices must manually scan and then choose the wireless technology for communication with their devices.

In another approach, if a wireless device is within the operating range of another wireless device, automated pairing is possible between the devices. However, this may require that multiple radios are operational to perform discovery and pairing operations. This may result in additional power consumption.

In some approaches, a short range radio 116 is used to enable a long range radio 114. These approaches switch from a short range radio (e.g., BT radio) to longer range radio (e.g., Wi-Fi) based on degradation of data links. However, these approaches do not consider how to switch from a long range radio 114 to a short range radio 116.

The systems and methods described herein provide for automatically switching and connecting different wireless technologies used for communication between devices. In certain data exchange situations between devices, switching RF communication technology from the long range radio 114 to the short range radio 116 may result in power savings.

The wireless communication system 100 may include an announcing device 102 and a monitoring device 104. In an implementation, the announcing device 102 and the monitoring device 104 may be communication devices, also referred to as UEs, wireless communication devices or mobile devices.

The announcing device 102 may include a long range radio 114a that is configured with ProSe functionality. The announcing device 102 may also include one or more short range radios 116a. As described above, short range radios 116a may include Bluetooth, Wi-Fi or other wireless technologies for wireless communication.

The long range radio 114a and the short range radio 116a may be physically located in the same announcing device 102 or the radios 114a, 116a may reside in separate locations but are linked to the announcing device 102.

The monitoring device 104 may also include a long range radio 114b that is configured with ProSe functionality. The monitoring device 104 may also include one or more short range radios 116b. As with the announcing device 102, the long range radio 114b and the short range radio 116b may be physically located in the same monitoring device 104 or the radios 114b, 116b may reside in separate locations but are linked to the monitoring device 104.

ProSe may use LTE signals to perform device-to-device communication. ProSe allows communication devices to directly communicate with each other using LTE radio resources allocated by the evolved NodeB (eNB). A feature of ProSe includes the discovery of devices within proximity of each other.

ProSe has two primary components. An “announcing device” broadcasts messages. A “monitoring device” listens for announcements or messages from the announcing device. While FIG. 1 shows a separate announcing device 102 and monitoring device 104, it should be noted that a ProSe device can be both an announcer and a monitor.

An LTE signal may be used for transporting ProSe messages. The ProSe messages may include information such as advertisements, requests and presence of services. Announcements from the announcing device 102 can be broadcasted as open (public) or restricted (private) discovery messages. The open discovery messages are available for all nearby devices. The restricted discovery messages are limited to specific devices. Both the announcing device 102 and the monitoring device 104 may send and receive open or restricted messages.

The announcing device 102 may transmit one or more long range signals 106 from the long range radio 114. In the case of ProSe, the announcing device 102 may periodically broadcast ProSe messages to surrounding devices. The message sent by the announcing device 102 may be an advertisement that requires a short range radio 116 connection (e.g., Bluetooth) if additional information is desired.

The one or more long range signals 106 may include a value that the monitoring device 104 can use to calculate a distance 110 from the monitoring device 104 to the announcing device 102. In an implementation, the one or more long range signals 106 may include timing advance values from LTE Medium Access Control (MAC) layer radio signals. In ProSe, the announcing device 102 is the equivalent of an LTE evolved NodeB (eNB). The announcing device 102 may transmit a timing advance command so that the monitoring device 104 adjusts its uplink transmission timing.

The monitoring device 104 may calculate the distance 110 from the monitoring device 104 to the announcing device 102 based on the one or more received long range signals 106. The one or more long range signals 106 may be received by the long range radio 114b.

In an implementation, the monitoring device 104 may include a distance calculator 108. The distance calculator 108 may measure and analyze the one or more received long range signals 106 to determine the distance 110 between the announcing device 102 and the monitoring device 104. The distance calculator 108 may determine a distance value 112 using the one or more received long range signals 106.

In the case of ProSe, the monitoring device 104 may calculate the distance 110 using the timing advance values from the LTE signals. Propagation delay is calculated by using the value in the timing advance control transmitted by the announcing device 102. Using the speed of light and the propagation value, a distance value 112 may be calculated by the monitoring device 104.

The monitoring device 104 may determine whether the distance 110 is within the operating range 119 of the short range radio 116b. For example, the distance value 112 may be compared with the operating range 119 of the short range radio 116b that the monitoring device 104 wants to switch to (e.g., BT or Wi-Fi).

Once a determination has been made that the monitoring device 104 is within operating range 119 of the of the short range radio 114b, the monitoring device 104 may transmit short range radio configuration parameters 118 using the long range radio 114b. The short range radio configuration parameters 118 may include security and device identification parameters for the short range radio 116b. The short range radio configuration parameters 118 may be used for authentication during a pairing process.

The short range radio configuration parameters 118 may be privately transmitted using messaging protocols. In the case of ProSe, the short range radio configuration parameters 118 may be broadcast in a restricted ProSe message. The restricted message may only be read by the announcing device 102.

The monitoring device 104 and the announcing device 102 may automatically switch from the long range radio 114 to the short range radio 116 based on the short range radio configuration parameters 118. Once the monitoring device 104 transmits the short range radio configuration parameters 118, the monitoring device 104 may activate its short range radio 116b. Similarly, once the announcing device 102 receives the short range radio configuration parameters 118, the announcing device 102 may activate its short range radio 116a. The announcing device 102 and the monitoring device 104 may then immediately begin a pairing process using the exchanged short range radio configuration parameters 118.

If the pairing process succeeds, the announcing device 102 and the monitoring device 104 may exchange data. The announcing device 102 and the monitoring device 104 may (optionally) disable some or all functionality of the long range radios 114 upon establishing a connection on the short range radios 116. For example, the announcing device 102 and the monitoring device 104 may disable ProSe functionality, thus releasing the radio resources allocated by the eNB which can then be used by other wireless devices while conserving battery.

If the pairing process fails, the monitoring device 104 may transmit a private failed link message. The short range radios 116 may be turned off. The ProSe functionality may be re-enabled and the process to reconnect begins.

The described systems and methods provide the following benefits. Automatic switching of radio technologies used for communication between devices may be implemented. Different wireless transmitters and receivers (e.g., ProSe, BT, Wi-Fi) are automatically turned on or off. The benefits of the described systems and methods also include avoiding additional device discovery. Authentication parameters (i.e., short range radio configuration parameters 118) required for BT and Wi-Fi connections are exchanged prior to pairing. This eliminates the need for a discovery process but a secure transport channel is still preserved. Additionally, a user interface for inputting passkey/password needed for BT/Wi-Fi authentication is not required. Furthermore, switching from long range radio to short range radio reduces battery consumption for mobile devices.

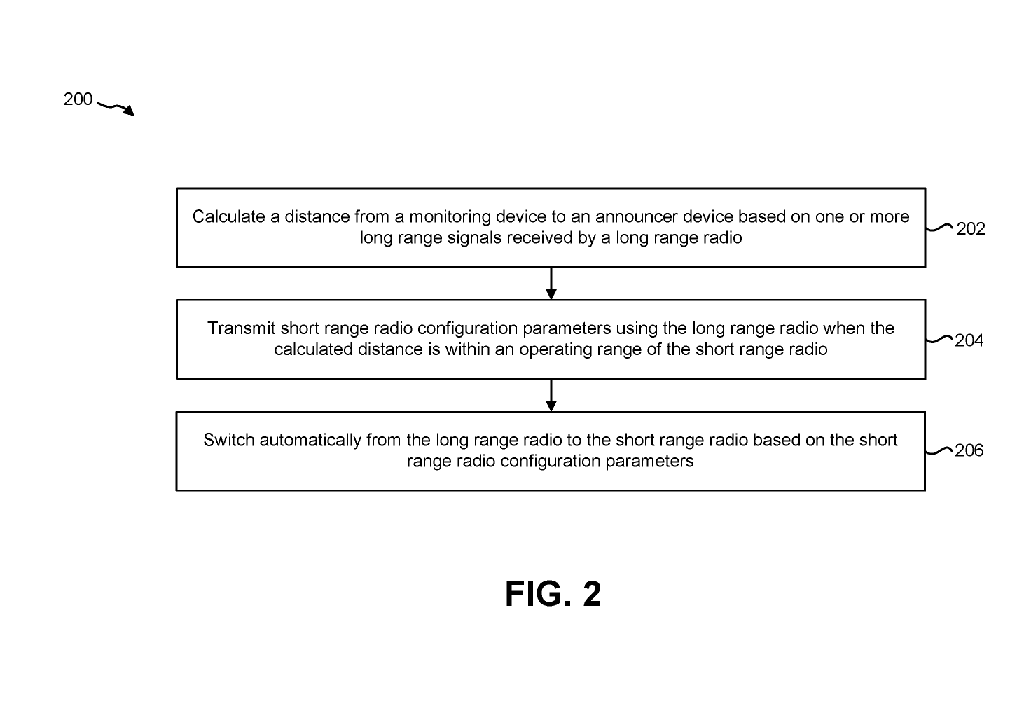

FIG. 2 is a flow diagram illustrating a method 200 for switching wireless communication technologies between devices. The method 200 may be implemented by a monitoring device 104. The monitoring device 104 may include a long range radio 114b and a short range radio 116b. An example of the long range radio 114b is an LTE ProSe radio. Examples of the short range radio 116b include a Bluetooth (BT) radio or a Wi-Fi radio. The short range radio 116b has an operating range 119 that is less than the operating range of the long range radio 114b.

The monitoring device 104 may calculate 202 a distance 110 from the monitoring device 104 to an announcing device 102 based on one or more long range signals 106 received by the long range radio 114b. For example, the monitoring device 104 may receive a ProSe broadcast announcement from the announcing device 102. The monitoring device 104 may calculate 202 the distance 110 using timing advance values from the LTE signals.

The monitoring device 104 may transmit 204 short range radio configuration parameters 118 using the long range radio 114b when the calculated distance 110 is within an operating range 119 of the short range radio 116b. For example, the monitoring device 104 may compare the calculated distance value 112 with the operating range 119 of the short range radio 116b that the monitoring device 104 wants to switch to. Once a determination has been made that the monitoring device 104 is within operating range 119 of the of the short range radio 114b, the monitoring device 104 may transmit 204 the short range radio configuration parameters 118 using the long range radio 114b.

The short range radio configuration parameters 118 may be broadcast in a restricted ProSe message. The restricted ProSe message may include security and device identification parameters for the short range radio 116b. The short range radio configuration parameters 118 may be used for authentication during a pairing process.

The monitoring device 104 may switch 206 automatically from the long range radio 114b to the short range radio 116b based on the short range radio configuration parameters 118. For example, the monitoring device 104 may activate the short range radio 116b. The monitoring device 104 may then perform a pairing process with the announcing device 102 for the short range radio 116b using the short range radio configuration parameters 118 transmitted by the long range radio 114b.

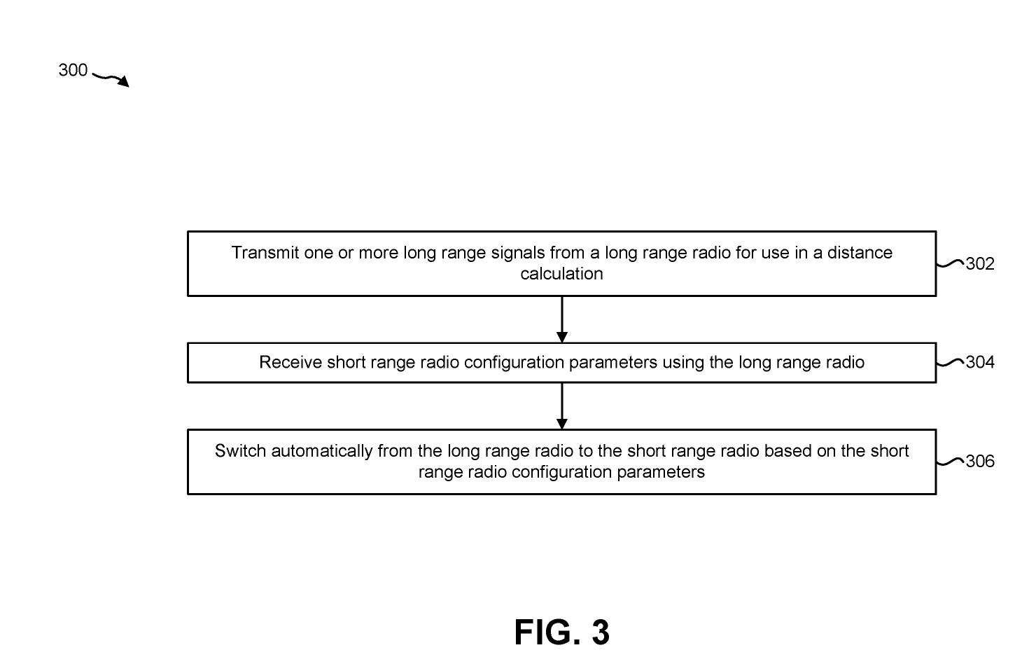

FIG. 3 is a flow diagram illustrating another method 300 for switching wireless communication technologies between devices. The method 300 may be implemented by an announcing device 102. The announcing device 102 may include a long range radio 114b and a short range radio 116b. An example of the long range radio 114a includes an LTE ProSe radio. Examples of the short range radio 116a include a Bluetooth (BT) radio or a Wi-Fi radio.

The announcing device 102 may transmit 302 one or more long range signals 106 from the long range radio 114a for use in a distance calculation. For example, the announcing device 102 may transmit 302 a ProSe broadcast announcement that includes calculated distance value. A monitoring device 104 may calculate the distance 110 using timing advance values from the LTE signals.

The announcing device 102 may receive 304 short range radio configuration parameters 118 using the long range radio 114a. For example, the short range radio configuration parameters 118 may be included in restricted ProSe message broadcast from the monitoring device 104. The restricted ProSe message may include security and device identification parameters for the short range radio 116b of the monitoring device 104. The short range radio configuration parameters 118 may be used for authentication during a pairing process.

The announcing device 102 may switch 306 automatically from the long range radio 114a to the short range radio 116a based on the short range radio configuration parameters 118. For example, the announcing device 102 may activate the short range radio 116a. The announcing device 102 may then perform a pairing process with the monitoring device 104 for the short range radio 116a using the short range radio configuration parameters 118 received by the long range radio 114a.

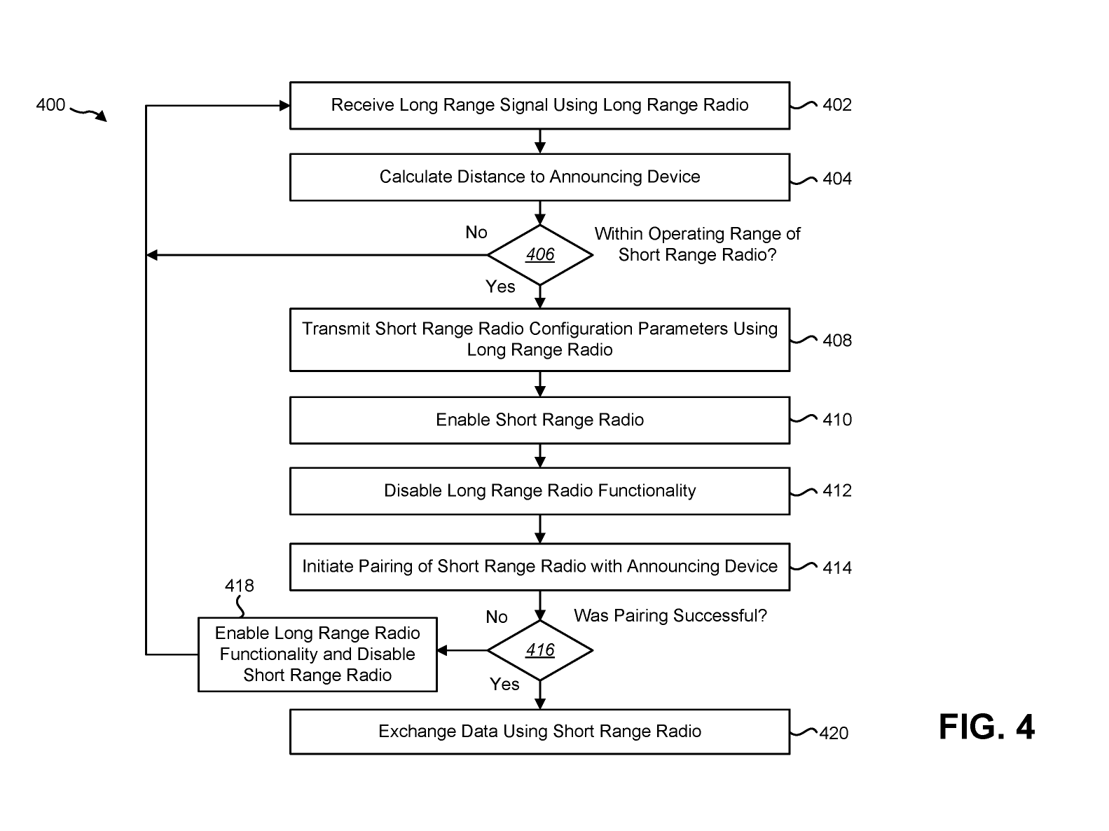

FIG. 4 is a flow diagram illustrating yet another method 400 for switching wireless communication technologies between devices. The method 400 may be implemented by a monitoring device 104. As described above, the monitoring device 104 may include a long range radio 114b (e.g., LTE radio) and a short range radio 116b (e.g., BT radio or Wi-Fi radio). At the start of the method 400, the short range radio 116b may be disabled (e.g., turned-off).

The monitoring device 104 may receive 402 a long range signal 106 using the long range radio 114b. For example, the long range signal 106 may be a ProSe broadcast announcement received from an announcing device 102.

The monitoring device 104 may calculate 404 the distance 110 to the announcing device 102. For example, the monitoring device 104 may calculate 404 the distance 110 using timing advance values included in the timing advance command message transmitted by the announcing device 102.

The monitoring device 104 may determine 406 whether it is within the operating range 119 of the short range radio 116b. If the monitoring device 104 is not within the operating range 119 of the short range radio 116b, then the monitoring device 104 may continue to receive 402 long range signals 106 using the long range radio 114b.

If the monitoring device 104 determines 406 that it is within the operating range 119 of the short range radio 116b, then the monitoring device 104 may transmit 408 short range radio configuration parameters 118 using the long range radio 114b. The short range radio configuration parameters 118 may be broadcast in a restricted ProSe message. The restricted ProSe message may include security and device identification parameters for the short range radio 116b.

The monitoring device 104 may enable 410 the short range radio 116b. The monitoring device 104 may also disable 412 some or all long range radio functionality. For example, the monitoring device 104 may disable (e.g., turn off) the ProSe functionality, thus releasing the radio resources that can then be used by other users while conserving battery power.

The monitoring device 104 may initiate pairing of the short range radio 116b with the announcing device 102. The announcing device 102 and the monitoring device 104 may begin a pairing process using the exchanged short range radio configuration parameters 118.

The monitoring device 104 may determine 416 whether the pairing was successful. If the pairing was not successful, the monitoring device 104 may transmit a restricted failed link message. The monitoring device 104 may then enable 418 the long range radio functionality (e.g., LTE ProSe functionality) and disable the short range radio 116b. The monitoring device 104 may continue to receive 402 long range signals 106 using the long range radio 114b.

If the monitoring device 104 determines 416 that the pairing was successful, the monitoring device 104 may exchange 420 data with the announcing device 102 using the short range radio 116b. For example, the monitoring device 104 may send or receive data using a Bluetooth radio or Wi-Fi radio.

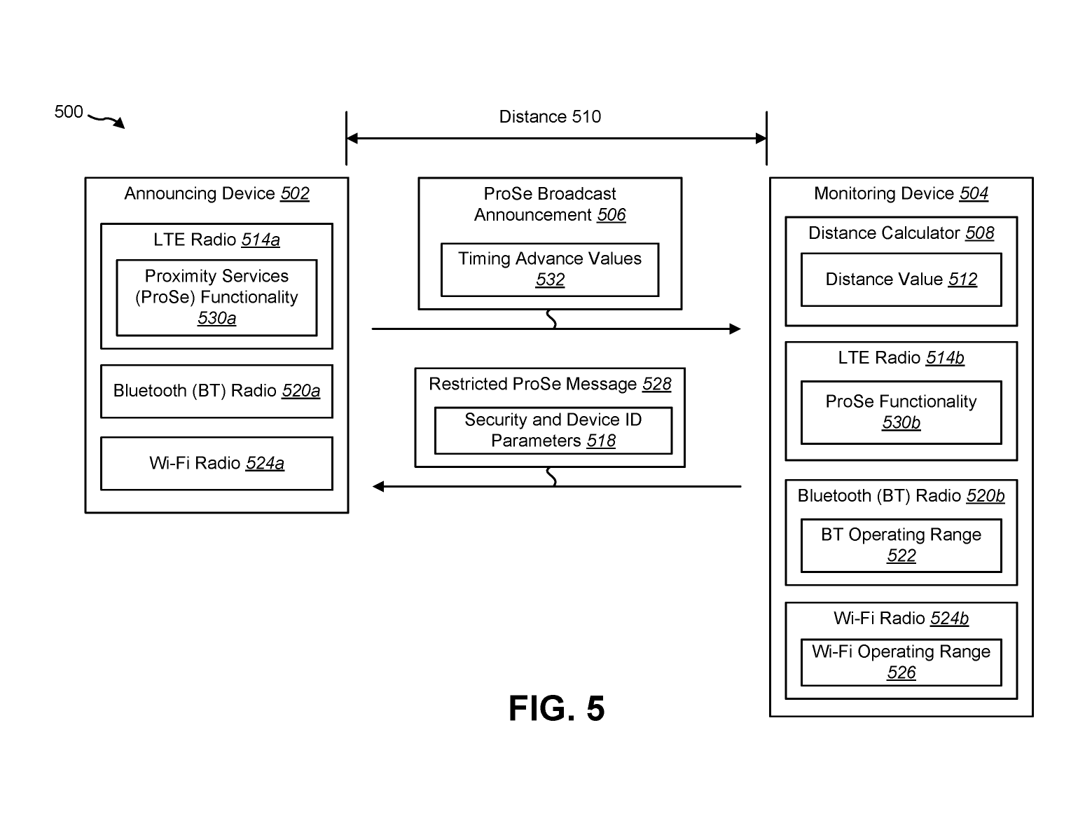

FIG. 5 is a block diagram illustrating an implementation of a wireless communication system 500 for switching wireless communication technologies. The system 500 may include an announcing device 502 and a monitoring device 504. The announcing device 502 may be implemented in accordance with the announcing device 102 of FIG. 1. Similarly, the monitoring device 504 may be implemented in accordance with the monitoring device 104 of FIG. 1.

In the implementation of FIG. 5, the announcing device 502 includes an LTE radio 514a configured with ProSe functionality 530a. The LTE radio 514a is an implementation of the long range radio 114a of FIG. 1. The announcing device 502 may also include one or both of a Bluetooth (BT) radio 520a and a Wi-Fi radio 524a, which are implementations of the short range radio 116a of FIG. 1.

The monitoring device 504 includes an LTE radio 514b configured with ProSe functionality 530b. The LTE radio 514b is an implementation of the long range radio 114b of FIG. 1. The monitoring device 504 may also include one or both of a Bluetooth (BT) radio 520b and a Wi-Fi radio 524b, which are implementations of the short range radio 116b of FIG. 1.

The BT radio 520b has a BT operating range 522. As described above, this BT operating range 522 may be approximately 10 meters. The Wi-Fi radio 524b has a Wi-Fi operating range 526 of approximately 30 meters.

The announcing device 502 may periodically transmit a ProSe broadcast announcement 506 using the long range radio 114. The LTE radio 514a used to transport the ProSe broadcast message 506 contains timing advance information 532.

The monitoring device 504 may calculate the distance 510 from the monitoring device 504 to the announcing device 502 based on the ProSe broadcast announcement 506. In an implementation, a distance calculator 508 may measure and analyze the ProSe broadcast announcement 506 using the timing advance values 532 to determine a distance value 512 between the announcing device 502 and the monitoring device 504.

The monitoring device 504 may determine whether the distance 510 is within range of the BT radio 520b or the Wi-Fi radio 524b. For example, if the monitoring device 504 wants to switch to the BT radio 520b, the monitoring device 504 may compare the BT operating range 522 with the calculated distance value 512. If the monitoring device 504 wants to switch to the Wi-Fi radio 524b, the monitoring device 504 may compare the Wi-Fi operating range 526 with the calculated distance value 512.

Once the monitoring device 504 determines that the distance 510 is within range of the BT radio 520b or the Wi-Fi radio 524b, the monitoring device 504 may transmit a restricted ProSe message 528 to the announcing device 502. The restricted ProSe message 528 may include security and device identification parameters 518.

For a BT radio 520b, the restricted ProSe message 528 may include one or more of the following security and device identification parameters 518. A password/passkey may be included. The password/passkey may be an agreed upon security key required for authentication before data exchange. The media access control (MAC) address may be included and/or other unique identifiers for the Bluetooth connection. The type of connection to use (i.e., Bluetooth) may also be included in the security and device identification parameters 518.

For a Wi-Fi radio 524b, one or more of the following security and device identification parameters 518 may be included in the restricted ProSe message 528: Password, MAC address, Wi-Fi network name, Wi-Fi as type of connection.

Once the restricted ProSe message 528 is transmitted, the monitoring device 504 and the announcing device 502 may automatically switch from the LTE radio 514 to either the BT radio 520 or the Wi-Fi radio 524. The announcing device 502 and the monitoring device 504 may then immediately begin a pairing process using the exchanged security and device identification parameters 518. The announcing device 502 and the monitoring device 504 may (optionally) disable ProSe functionality 530 upon establishing a connection on the BT radio 520 or the Wi-Fi radio 524.

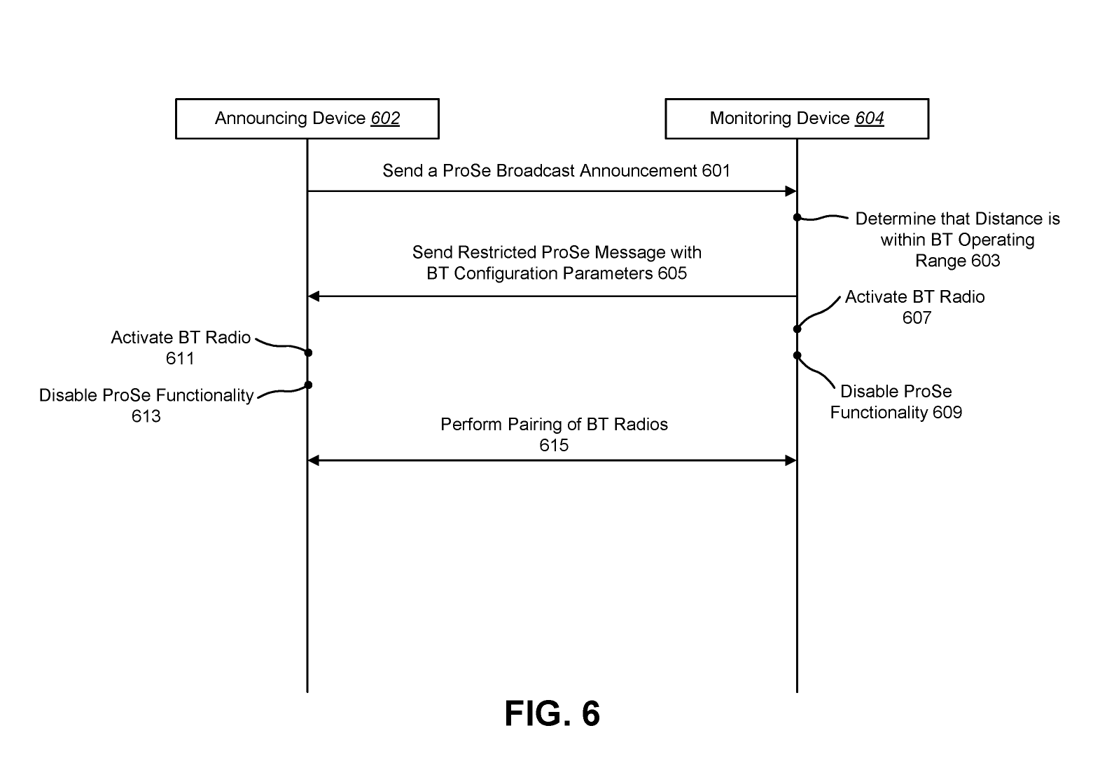

FIG. 6 is a sequence diagram illustrating an implementation of switching between wireless communication technologies. In this implementation, an announcing device 602 and a monitoring device 604 are configured with an LTE radio 514 and a Bluetooth (BT) radio 520.

The announcing device 602 may send 601 a ProSe broadcast announcement 506. The ProSe broadcast announcement 506 may include timing advance values 532. The monitoring device 604 may receive the ProSe broadcast announcement 506. Surrounding devices may receive the ProSe broadcast announcements 506 but the monitoring device 604 is interested in connecting with the announcing device 602 using BT.

The user of monitoring device 604 may start moving towards announcing device 602. As the monitoring device 604 approaches the announcing device 602, the LTE signals that are periodically transmitted from announcing device 602 are measured and analyzed by the monitoring device 604 to determine the distance 510 between the announcing device 602 and the monitoring device 604.

The monitoring device 604 may determine 603 that the distance 510 between the monitoring device 604 and the announcing device 602 is within the BT operating range 520b. For example, the monitoring device 604 may use the timing advance values 532 to calculate a distance value 512. The monitoring device 604 may then compare the distance value 512 to the BT operating range 522.

The monitoring device 604 may send 605 a restricted ProSe message 528 to the announcing device 602 using the LTE radio 514b. The restricted ProSe message 528 may include security and device identification parameters 518. The monitoring device 604 may then activate 607 its BT radio 520b and disable 609 ProSe functionality 530b.

Upon receiving the restricted ProSe message 528, the announcing device 602 may activate 611 its BT radio 520a and disable ProSe functionality 530a. The announcing device 602 and the monitoring device 604 may immediately perform 615 pairing of the BT radios 520a-b followed by a secure data exchange using the configuration parameters 518. As a result, no user interface for authentication is required. Because the BT radio 520a-b is turned on automatically, the need to manually enable the BT radio 520a-b is eliminated.

In another implementation (not shown), the announcing device 602 and the monitoring device 604 may switch between ProSe and Wi-Fi. The methods described above apply with a few differences. The monitoring device 604 may compare the calculated distance value 512 with the Wi-Fi operating range 526. If the monitoring device 604 determines that Wi-Fi is within range, the restricted ProSe message 528 may be sent with security and device ID parameters 518. Then, the Wi-Fi radios 524a-b may be turned on. ProSe functionality 530b may be disabled on the announcing device 602 and/or monitoring device 604 once Wi-Fi data exchange starts.

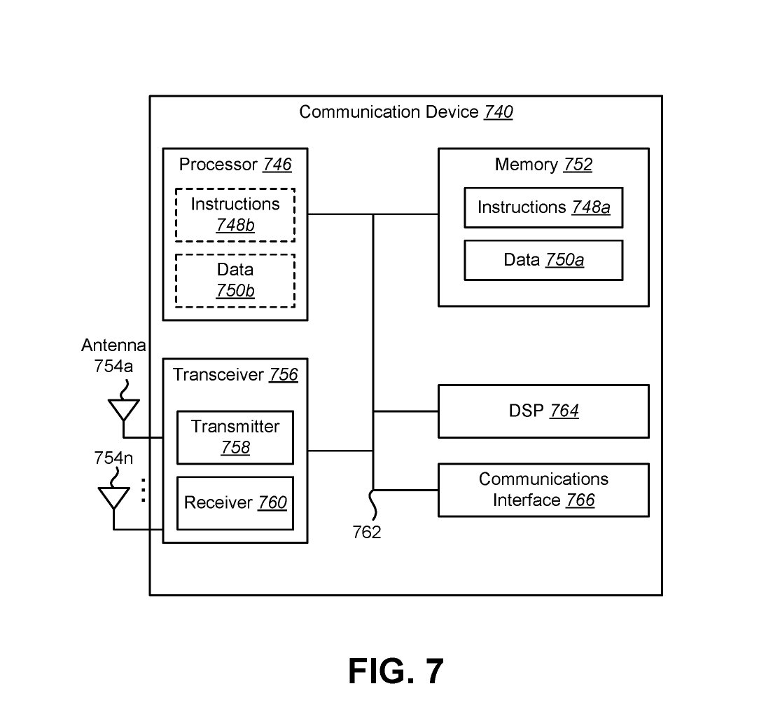

FIG. 7 illustrates various components that may be utilized in a communication device 740. The communication device 740 described in connection with FIG. 7 may be implemented in accordance with one or more of the announcing device 102 or monitoring device 104 described in connection with FIG. 1.

The communication device 740 includes a processor 746 that controls operation of the communication device 740. The processor 746 may also be referred to as a central processing unit (CPU). Memory 752, which may include read-only memory (ROM), random access memory (RAM), a combination of the two or any type of device that may store information, provides instructions 748a and data 750a to the processor 746. A portion of the memory 752 may also include non-volatile random access memory (NVRAM). Instructions 748b and data 750b may also reside in the processor 746. Instructions 748b and/or data 750b loaded into the processor 746 may also include instructions 748a and/or data 750a from memory 752 that were loaded for execution or processing by the processor 746. The instructions 748b may be executed by the processor 746 to implement one or more of the methods described above.

The communication device 740 may also include a housing that contains one or more transmitters 758 and one or more receivers 760 to allow transmission and reception of data. The transmitter(s) 758 and receiver(s) 760 may be combined into one or more transceivers 756. One or more antennas 754a-n are attached to the housing and electrically coupled to the transceiver 756.

The various components of the communication device 740 are coupled together by a bus system 762, which may include a power bus, a control signal bus and a status signal bus, in addition to a data bus. However, for the sake of clarity, the various buses are illustrated in FIG. 7 as the bus system 762. The communication device 740 may also include a digital signal processor (DSP) 764 for use in processing signals. The communication device 740 may also include a communications interface 766 that provides user access to the functions of the communication device 740. The communication device 740 illustrated in FIG. 7 is a functional block diagram rather than a listing of specific components.

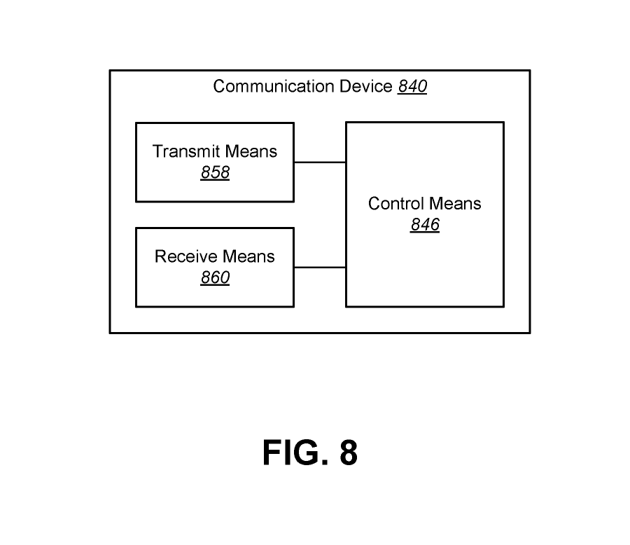

FIG. 8 is a block diagram illustrating one implementation of a communication device 840 in which systems and methods for switching wireless communication technologies between devices may be implemented. The communication device 840 includes transmit means 858, receive means 860 and control means 846. The transmit means 858, receive means 860 and control means 846 may be configured to perform one or more of the functions described in connection with FIG. 1 above. FIG. 7 above illustrates one example of a concrete apparatus structure of FIG. 8. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the announcing device 102 or monitoring device 104 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the announcing device 102 or monitoring device 104 according to the systems and methods described above may be realized as an LSI that is a typical integrated circuit. Each functional block of the announcing device 102 or monitoring device 104 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A method by a monitoring device, comprising:
calculating a distance from the monitoring device to an announcing device based on one or more long range signals received by a long range radio;
transmitting short range radio configuration parameters using the long range radio when the calculated distance is within an operating range of a short range radio; and
switching automatically from the long range radio to the short range radio based on the short range radio configuration parameters.

2. The method of claim 1, wherein the long range radio is a Long-Term Evolution (LTE) radio with proximity services (ProSe) and wherein the one or more long range signals comprise a ProSe broadcast announcement.

3. The method of claim 2, wherein the short range radio configuration parameters are broadcast in a restricted ProSe message.

4. The method of claim 3, wherein the restricted ProSe message includes security and device identification parameters.

5. The method of claim 2, further comprising disabling ProSe functionality on the long range radio upon switching to the short range radio.

6. The method of claim 1, wherein the short range radio is a Bluetooth radio.

7. The method of claim 1, wherein the short range radio is a Wi-Fi radio.

8. The method of claim 1, further comprising pairing the short range radio using the short range radio configuration parameters transmitted by the long range radio.

9. The method of claim 1, further comprising disabling at least some long range radio functionality upon switching to the short range radio.

10. A monitoring device, comprising:
a processor; and
memory in electronic communication with the processor, wherein
instructions stored in the memory are executable to:
calculate a distance from the monitoring device to an announcing device based on one or more long range signals received by a long range radio;
transmit short range radio configuration parameters using the long range radio when the calculated distance is within an operating range of a short range radio; and
switch automatically from the long range radio to the short range radio based on the short range radio configuration parameters.

11. The monitoring device of claim 10, wherein the long range radio is an LTE radio with proximity services (ProSe) and wherein the one or more long range signals comprise a ProSe broadcast announcement.

12. The monitoring device of claim 11, wherein the short range radio configuration parameters are broadcast in a restricted ProSe message.

13. The monitoring device of claim 11, further comprising instructions executable to disable ProSe functionality on the long range radio upon switching to the short range radio.

14. The monitoring device of claim 10, further comprising instructions executable to pair the short range radio using the short range radio configuration parameters transmitted by the long range radio.

15. A method by an announcing device, comprising:
transmitting one or more long range signals from a long range radio, wherein the one or more long range signals include a value that a monitoring device may use to calculate a distance from the monitoring device to an announcing device;
receiving short range radio configuration parameters using the long range radio; and
switching automatically from the long range radio to a short range radio based on the short range radio configuration parameters.

16. The method of claim 15, wherein the long range radio is an LTE radio with proximity services (ProSe) and wherein the long range signal comprises a ProSe broadcast announcement.

17. The method of claim 16, wherein the short range radio configuration parameters are received in a restricted ProSe message.

18. The method of claim 17, wherein the restricted ProSe message includes security and device identification parameters.

19. The method of claim 18, further comprising disabling ProSe functionality on the long range radio upon switching to the short range radio.

20. The method of claim 15, further comprising pairing the short range radio using the short range radio configuration parameters received by the long range radio.

21. The method of claim 15, further comprising disabling at least some long range radio functionality upon switching to the short range radio.

22. An announcing device, comprising:
a processor; and
memory in electronic communication with the processor, wherein
instructions stored in the memory are executable to:
transmit one or more long range signals from a long range radio, wherein the one or more long range signals include a value that a monitoring device may use to calculate a distance from the monitoring device to an announcing device;
receive short range radio configuration parameters using the long range radio; and
switch automatically from the long range radio to a short range radio based on the short range radio configuration parameters.

23. The announcing device of claim 22, wherein the long range radio is an LTE radio with proximity services (ProSe) and wherein the long range signal comprises a ProSe broadcast announcement.

24. The announcing device of claim 23, wherein the short range radio configuration parameters are received in a restricted ProSe message.

25. The announcing device of claim 23, further comprising instructions executable to disable ProSe functionality on the long range radio upon switching to the short range radio.

26. The announcing device of claim 22, further comprising instructions executable to pair the short range radio using the short range radio configuration parameters received by the long range radio.
